(19) United States
(12) Patent Application Publication
(10) Pub. No.: US 2018/0335906 A1
(43) Pub. Date: Nov. 22, 2018

(54) APPLICATION ICON PREVIEWING METHOD AND DEVICE, AND ELECTRONIC DEVICE

(71) Applicant: BEIJING KINGSOFT INTERNET SECURITY SOFTWARE CO., LTD., BEIJING (CN)

(72) Inventor: Sini HE, BEIJING (CN)

(21) Appl. No.: 15/923,822

(22) Filed: Mar. 16, 2018

(30) Foreign Application Priority Data
May 19, 2017 (CN) 201710357840.7

(51) Int. Cl. G06F 3/0483; G06F 3/0481; G06F 3/0488

(52) U.S. Cl. CPC G06F 3/0483; G06F 3/04815; G06F 3/04883; G06F 3/04817

(57) ABSTRACT

Embodiments of the present disclosure provide an application icon previewing method, including: receiving a touch instruction for a page slide prompt input on any one of at least one icon display page; and scaling down the at least one icon display page according to the touch instruction, and displaying at least one scaled-down icon display page on a screen. Embodiments of the present disclosure provide further provide an application icon previewing device and an electronic device.

### CROSS-REFERENCE TO RELATED APPLICATIONS

This application claims priority to and benefits of Chinese Patent Application Serial No. 201710357840.7, filed with the State Intellectual Property Office of P. R. China on May 19, 2017, the entire content of which is incorporated herein by reference.

### FIELD

The present disclosure relates to a field of electronic technology, and more particularly, to an application icon previewing method, an application icon previewing device and an electronic device.

### BACKGROUND

A third-party desktop (non-system desktop) can be installed in an electronic device (such as a cell phone, or a tablet), and can be set as a default desktop to replace a system desktop. In general, the third-party desktop has richer functions than the system desktop, and the user can customize a display effect by setting the third-party desktop. Some third-party desktops have functions such as changing themes that can give completely different visual display effects to the user.

### SUMMARY

Embodiments of the present disclosure provide an application icon previewing method, an application icon previewing device and an electronic device.

Embodiments of the present disclosure provide an application icon previewing method. The method includes: receiving a touch instruction for a page slide prompt input on any one of at least one icon display page; and scaling down the at least one icon display page according to the touch instruction, and displaying at least one scaled-down icon display page on a screen.

Accordingly, embodiments of the present disclosure provide an application icon previewing device. The device includes an instruction receiving module and a page displaying module.

The instruction receiving module is configured to receive a touch instruction for a page slide prompt input on any one of at least one icon display page.

The page displaying module is configured to scale down the at least one icon display page according to the touch instruction, and to display at least one scaled-down icon display page on a screen.

Accordingly, embodiments of the present disclosure provide an electronic device, including a processor, a memory, a communication interface and a bus.

The processor, the memory and the communication interface are connected via the bus and communicate with each other.

The memory is configured to store executable program codes.

The processor is configured to execute a program corresponding to the executable program codes by reading the executable program codes stored in the memory, to perform operations: receiving a touch instruction for a page slide prompt input on any one of at least one icon display page; and scaling down the at least one icon display page according to the touch instruction, and displaying at least one scaled-down icon display page on a screen.

Accordingly, embodiment of the present disclosure provides a non-transitory computer readable storage medium. The storage medium is configured to store application programs. The application programs are configured to perform the application icon previewing method provided by the first aspect of embodiments of the present disclosure when executed.

Accordingly, embodiment of the present disclosure provides an application program. The application program is configured to perform the application icon previewing method provided by the first aspect of embodiments of the present disclosure when executed.

### BRIEF DESCRIPTION OF THE DRAWINGS

In order to clearly illustrate technical solutions of embodiments of the present disclosure, a brief description of drawings used in embodiments is given below. Obviously, the drawings in the following descriptions are only part embodiments of the present disclosure, and for those skilled in the art, other drawings can be obtained according to these drawings without creative labor.

FIG. 1 is a schematic diagram of an icon display page according to the related art;

FIG. 2 is a flow chart of an application icon previewing method according to an embodiment of the present disclosure;

FIG. 3 is a schematic diagram of a touch operation method according to an embodiment of the present disclosure;

FIG. 4 is a schematic diagram displaying an icon display page according to an embodiment of the present disclosure;

FIG. 5 is a schematic diagram displaying an icon display page according to another embodiment of the present disclosure;

FIG. 6 is a schematic diagram displaying an icon display page according to another embodiment of the present disclosure;

FIG. 7 is a flow chart of an application icon previewing method according to another embodiment of the present disclosure;

FIG. 8 is a block diagram of an application icon previewing device according to an embodiment of the present disclosure;

FIG. 9 is a block diagram of an electronic device according to an embodiment of the present disclosure.

### DETAILED DESCRIPTION

Reference will be made clearly and completely to technical solutions in the embodiments of the present disclosure with accompanying drawings. Obviously, the embodiments described here are only part of the embodiments of the present disclosure and are not all embodiments of the present disclosure. Based on the embodiments of the present disclosure, other embodiments obtained by those skilled in the art without creative labor are within the scope of the present disclosure.

As illustrated in FIG. 1, there is a page slide prompt (i.e. the dots) at the bottom of the screen, and each dot corresponds to an icon display page. When sliding to a certain icon display page, the dot corresponding to the certain icon display page may be highlighted. When the user needs to view other icon display pages, the user needs to slide the icon display page on the screen. The dot only plays a role of prompting the user to slide to a certain icon display page, having a single function, and the display form of the page is not rich enough.

To solve the problems that the function of the page slide prompt is single and the display form of the page is not rich enough in the related art, embodiments of the present disclosure provide an application icon previewing method, an application icon previewing device and an electronic device.

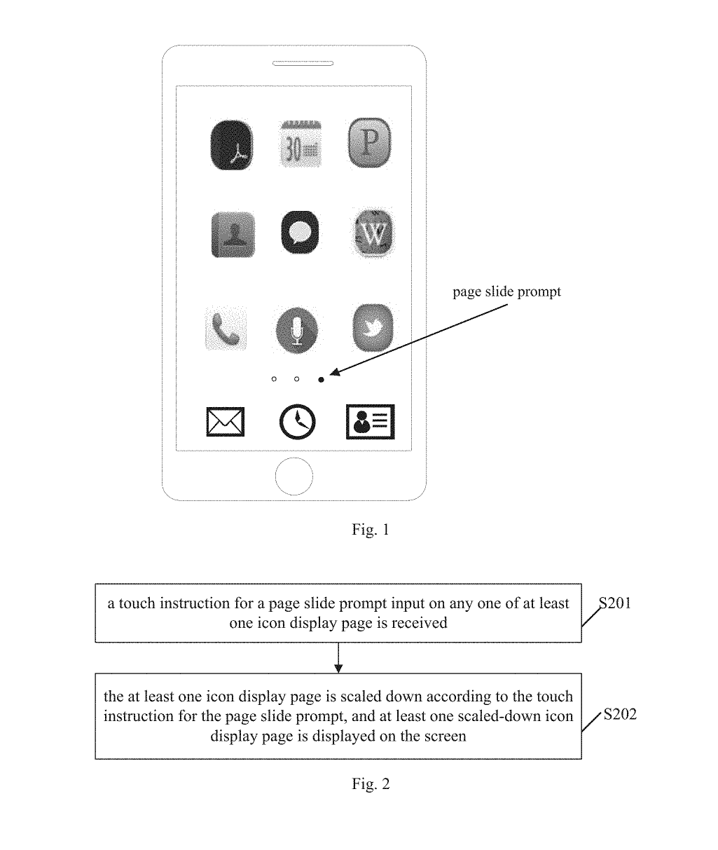

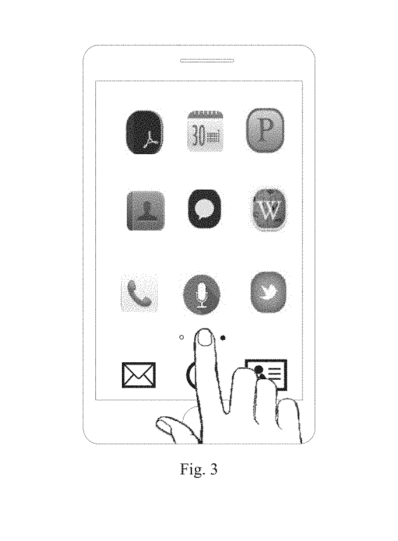

Referring to FIG. 2, FIG. 2 is a flow chart of an application icon previewing method according to an embodiment of the present disclosure. As illustrated in FIG. 2, the method according to embodiments of the present disclosure includes follows.

At block S201, a touch instruction for a page slide prompt input on any one of at least one icon display page is received.

In an implementation, there is one icon display page displayed on a screen currently. The icon display page includes application icons of a plurality of applications and a page slide prompt (i.e. dots). Each dot corresponds to one icon display page. When sliding to a certain icon display page, the dot corresponding to the certain icon display page is highlighted. The touch instruction input by the user at the dot can be received.

For example, as illustrated in FIG. 3, the screen may display three icon display pages, and each icon display page includes three dots. The dots are located directly under the application icons in the icon display page, and each dot corresponds to one icon display page. The screen slides to the third icon display page currently, thus the third dot is highlighted. The user can click the three dots to trigger following operations.

In at least one embodiment, it may be determined whether a duration of the touch instruction input on the page slide prompt is greater than a preset threshold. When the duration of the touch instruction input on the page slide prompt is greater than the preset threshold, the at least one icon display page is scaled down according to the touch instruction for the page slide prompt. When the duration of the touch instruction input on the page slide prompt is less than or equal to the preset threshold, the current display state of the at least one icon display page is maintained. The preset threshold may be 200 ms or 300 ms, but is not limited to the above values.

At block S202, the at least one icon display page is scaled down according to the touch instruction, and at least one scaled-down icon display page is displayed on the screen.

In an implementation, that the at least one scaled-down icon display page is displayed on the screen means that the least one scaled-down icon display page is displayed as a whole on the screen.

In an implementation, the at least one icon display page can be scaled down according to a preset scale-down ratio, and the at least one scaled-down icon display page can be combined into a three-dimensional object to display. At least one side of the three-dimensional object corresponds to the at least one icon display page respectively. The three-dimensional object may include a polyhedron, a cylinder, a sphere, etc.

Further, in at least one embodiment, an area size of the screen of a terminal is obtained, and the at least one icon display page is scaled down according to the area size of the terminal screen and the preset scaled-down ratio.

In at least one embodiment, after the at least one icon display page is scaled down according to the touch instruction for the page slide prompt, and the at least one scaled-down icon display page is displayed on the screen, a slide instruction input by the user on the page slide prompt can be received. According to the slide instruction, the at least one icon display page corresponding to the at least one side of the three-dimensional object is scrolled to display.

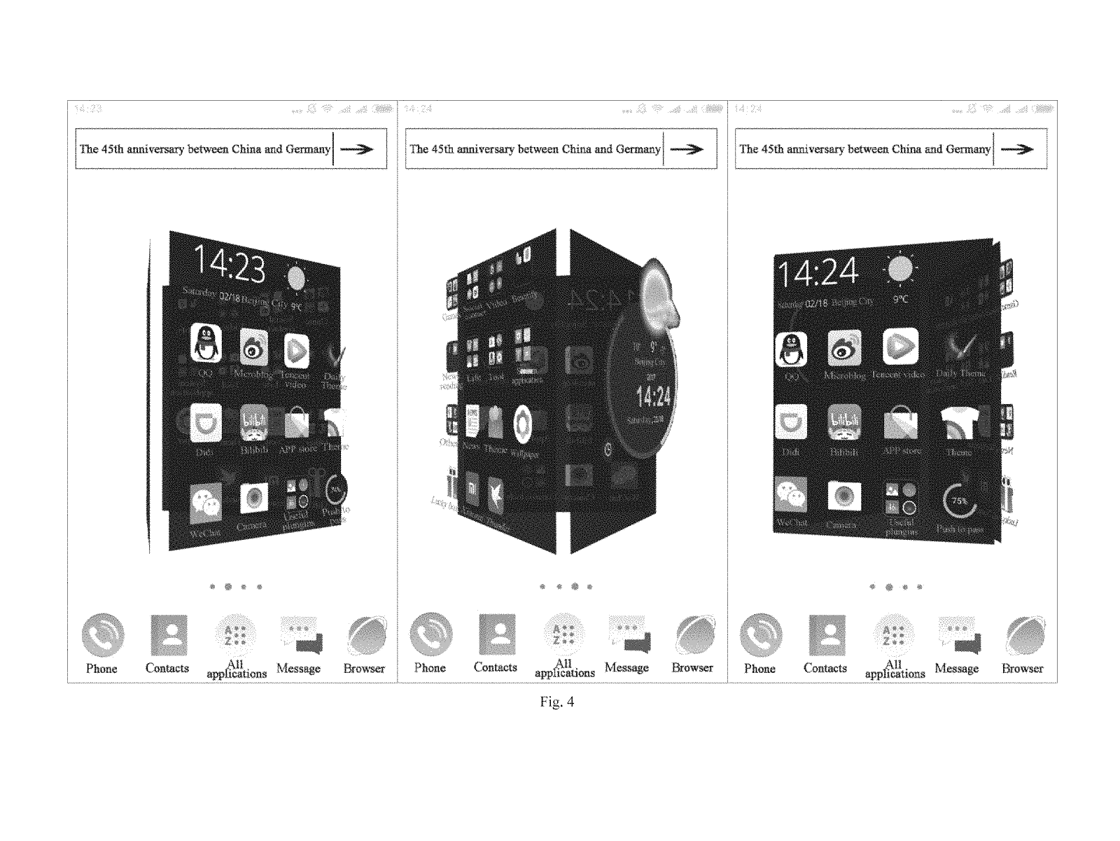

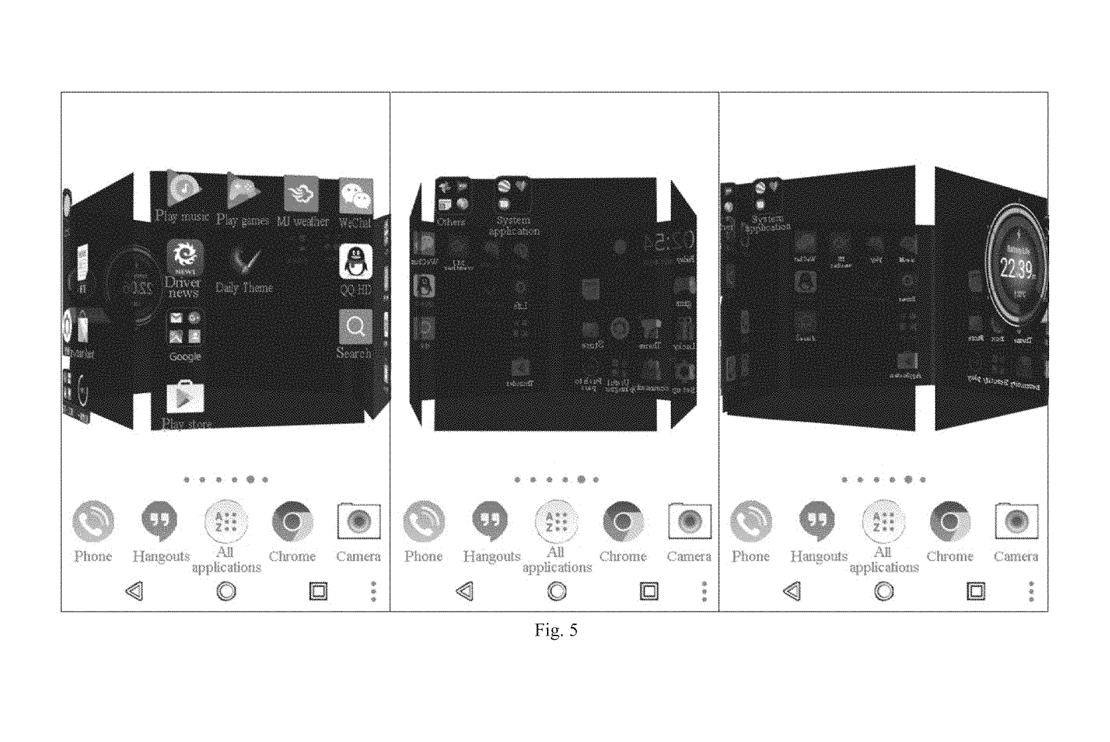

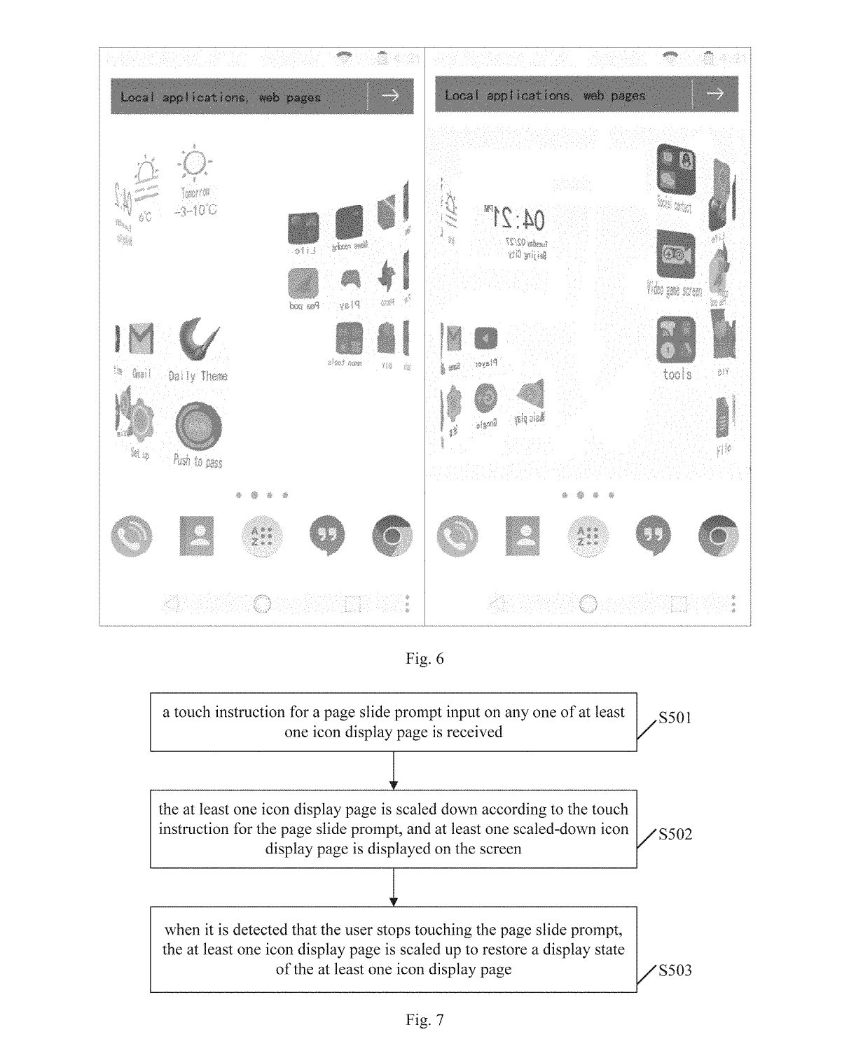

For example, as illustrated in FIG. 4, the current screen may display three icon display pages. The three icon display pages are scaled down simultaneously. A side of one icon display page can be connected with a side of another icon display page respectively to form a three-dimensional object. The three-dimensional object includes three sides, and each side corresponds to one icon display page. As illustrated in FIG. 5, the current screen may display five icon display pages. The five icon display pages are scaled down simultaneously. A side of one icon display page can be connected with a side of another icon display page respectively to form a three-dimensional object. The three-dimensional object includes five sides, and each side corresponds to one icon display page. As illustrated in FIG. 6, the current screen may display two icon display pages. The two icon display pages are scaled down and curved, and two sides of one icon display page can be connected with two sides of the other icon display page respectively to form a cylinder. The user can perform slide operation on the dots, and the three-dimensional object will be scrolled accordingly. When an icon display page is scrolled to a location nearest to the user in the three-dimensional space, application icons in the icon display page nearest to the user are mainly displayed, and the dot corresponding to the icon display page nearest to the user is highlighted. The user can slide back and forth at the dots, and the at least one icon display page may also scroll back and forth following the sliding direction of the user on the screen. When the user slides out of the location where the dots locate, the at least one icon display page may also stop scrolling accordingly.

In the embodiments of the present disclosure, the touch instruction for the page slide prompt input on one of the at least one icon display page is received first, and then the at least one icon display page is scaled down according to the touch instruction for the page slide prompt, and the at least one scaled-down icon display page is displayed on the screen. By extending functions of the page slide prompt, display effects of the page can be enriched.

Referring to FIG. 7, FIG. 7 is a flow chart of an application icon previewing method according to another embodiment of the present disclosure. As illustrated in FIG. 7, the method according to embodiments of the present disclosure includes follows.

At block S501, a touch instruction for a page slide prompt input on one of at least one icon display page is received.

In an implementation, there is one icon display page displayed on a screen currently. The icon display page includes application icons of a plurality of applications and a page slide prompt (i.e. dots). Each dot corresponds to one icon display page. When sliding to a certain icon display page, the dot corresponding to the certain icon display page is highlighted. The touch instruction inputted by the user at the dot can be received.

For example, as illustrated in FIG. 3, the screen may display three icon display pages, and each icon display page includes three dots. The dot is located directly under the application icons in the icon display page, and each dot corresponds to one icon display page. The screen slides to the third icon display page currently, thus the third dot is highlighted. The user can click the three dots to trigger following operations.

In at least one embodiment, it can be determined whether a duration of the touch instruction input on the page slide prompt is greater than the preset threshold. When the duration of the touch instruction input on the page slide prompt is greater than the preset threshold, the at least one icon display page is scaled down according to the touch instruction for the page slide prompt. When the duration of the touch instruction input on the page slide prompt is less than or equal to the preset threshold, the current display state of the at least one icon display page is maintained. The preset threshold may be 200 ms or 300 ms, but is not limited to the above values.

At block S502, the at least one icon display page is scaled down according to the touch instruction, and at least one scaled-down icon display page is displayed on the screen.

In an implementation of embodiments of the present disclosure, the at least one icon display page can be scaled down according to the preset scale-down ratio, and the at least one scaled-down icon display page can be combined into a three-dimensional object to display. At least one side of the three-dimensional object corresponds to the at least one icon display page respectively. The three-dimensional object may include the polyhedron, the cylinder, the sphere, etc.

Further, in at least one embodiment, the area size of the screen of a terminal is obtained, and the at least one icon display page is scaled down according to the area size of the terminal screen and the preset scaled-down factor.

In at least one embodiment, after the at least one icon display page is scaled down according to the touch instruction for the page slide prompt, and the at least one scaled-down icon display page is displayed on the screen, the slide instruction input by the user on the page slide prompt can be received. According to the slide instruction, the at least one icon display page corresponding to the at least one side of the three-dimensional object is scrolled to display.

For example, as illustrated in FIG. 4, the current screen may display three icon display pages. The three icon display pages are scaled down simultaneously. A side of one icon display page can be connected with a side of another icon display page respectively to form a three-dimensional object. The three-dimensional object includes three sides, and each side corresponds to one icon display page. As illustrated in FIG. 5, the current screen may display five icon display pages. The five icon display pages are scaled down simultaneously. A side of one icon display page can be connected with a side of another icon display page respectively to form a three-dimensional object. The three-dimensional object includes five sides, and each side corresponds to one icon display page. As illustrated in FIG. 6, the current screen may display two icon display pages. The two icon display pages are scaled down and curved, and two sides of one icon display page can be connected with two sides of the other icon display page respectively to form a cylinder. The user can perform slide operation on the dots, and the three-dimensional object will be scrolled accordingly. When an icon display page is scrolled to a location nearest to the user in the three-dimensional space, application icons in the icon display page nearest to the user are mainly displayed, and the dot corresponding to the icon display page nearest to the user is highlighted. The user can slide back and forth at the dots, and the at least one icon display page may also scroll back and forth following the sliding direction of the user on the screen. When the user slides out of the location where the dots locate, the at least one icon display page may also stop scrolling accordingly.

It should be noted that, in embodiments of the present disclosure, the at least one icon display page may also be combined into other three-dimensional forms to display.

At block S503, when it is detected that the user stops touching the page slide prompt, the at least one icon display page is scaled up to restore a display state of the at least one icon display page.

In an implementation, if a certain page slide prompt (i.e., a certain dot) is highlighted before the user stops touching the page slide prompt, the current screen displays the icon display page corresponding to the certain page slide prompt to restore the display state before the certain dot is touched after the user stops touching the page slide prompt and the at least one icon display page is scaled up.

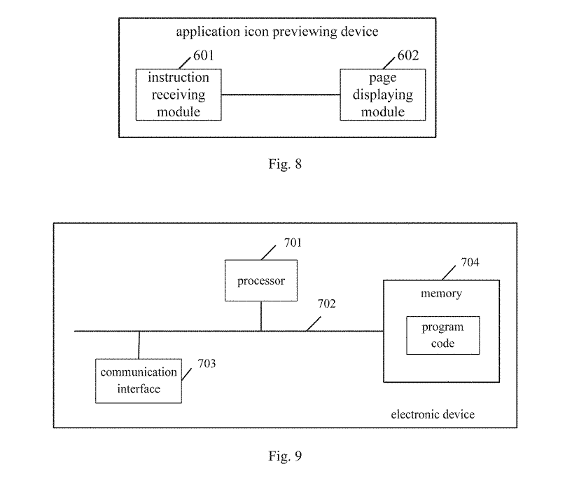

Referring to FIG. 8, FIG. 8 is a block diagram of an application icon previewing device according to an embodiment of the present disclosure. As illustrated in FIG. 8, the device includes an instruction receiving module 601 and a page displaying module 602.

The instruction receiving module 601 is configured to receive a touch instruction for a page slide prompt input on anyone of at least one icon display page.

In an implementation, there is one icon display page displayed on a screen currently. The icon display page includes application icons of a plurality of applications and a page slide prompt (i.e. dots). Each dot corresponds to one icon display page. When sliding to a certain icon display page, the dot corresponding to the certain icon display page is highlighted. The touch instruction input by the user at the dot can be received.

For example, as illustrated in FIG. 3, the screen may display three icon display pages, and each icon display page includes three dots. The dot is located directly under the application icons in the icon display page, and each dot corresponds to one icon display page. The screen slides to the third icon display page currently, thus the third dot is highlighted. The user can click the three dots to trigger following operations.

In at least one embodiment, it can be determined whether a duration of the touch instruction input on the page slide prompt is greater than the preset threshold. When the duration of the touch instruction input on the page slide prompt is greater than the preset threshold, the at least one icon display page is scaled down according to the touch instruction for the page slide prompt. When the duration of the touch instruction input on the page slide prompt is less than or equal to the preset threshold, the current display state of the at least one icon display page is maintained. The preset threshold may be 200 ms or 300 ms, but is not limited to the above values.

The page displaying module 602 is configured to scale down the at least one icon display page according to the touch instruction for the page slide prompt, and to display at least one scaled-down icon display page on the screen.

In an implementation, the at least one icon display page can be scaled down according to the preset scale-down ratio, and the at least one scaled-down icon display page can be combined into a three-dimensional object to display. At least one side of the three-dimensional object corresponds to the at least one icon display page respectively. The three-dimensional object may include the polyhedron, the cylinder, the sphere, etc.

Further, in at least one embodiment, the area size of the screen of a terminal is obtained, and the at least one icon display page is scaled down according to the area size of the terminal screen and the preset scaled-down factor.

In at least one embodiment, after the at least one icon display page is scaled down according to the touch instruction for the page slide prompt, and the at least one scaled-down icon display page is displayed on the screen, the slide instruction input by the user on the page slide prompt can be received. According to the slide instruction, the at least one icon display page corresponding to the at least one sides of the three-dimensional object is scrolled to display.

For example, as illustrated in FIG. 4, the current screen may display three icon display pages. The three icon display pages are scaled down simultaneously. A side of one icon display page can be connected with a side of another icon display page respectively to form a three-dimensional object. The three-dimensional object includes three sides, and each side corresponds to one icon display page. As illustrated in FIG. 6, the current screen may display five icon display pages. The five icon display pages are scaled down simultaneously. A side of one icon display page can be connected with a side of another icon display page respectively to form a three-dimensional object. The three-dimensional object includes five sides, and each side corresponds to one icon display page. As illustrated in FIG. 7, the current screen may display two icon display pages. The two icon display pages are scaled down and curved, and two sides of one icon display page can be connected with two sides of the other icon display page respectively to form a cylinder. The user can perform slide operation on the dots, and the three-dimensional object will be scrolled accordingly. When an icon display page is scrolled to a location nearest to the user in the three-dimensional space, application icons in the icon display page nearest to the user are mainly displayed, and the dot corresponding to the icon display page nearest to the user is highlighted. The user can slide back and forth at the dots, and the at least one icon display page may also scroll back and forth following the sliding direction of the user on the screen. When the user slides out of the location where the dots locate, the at least one icon display page may also stop scrolling accordingly.

In at least one embodiment, the page displaying module 602 is further configured to scale up the at least one icon display page to restore a display state of the at least one icon display page when it is detected that the user stops touching the page slide prompt.

In an implementation, if a certain page slide prompt (i.e., a certain dot) is highlighted before the user stops touching the page slide prompt, the current screen displays the icon display page corresponding to the certain page slide prompt to restore the display state before the certain dot is touched after the user stops touching the page slide prompt and the at least one icon display page is scaled up.

In the embodiments of the present disclosure, the touch instruction for the page slide prompt input on any one of the at least one icon display page is received first, and then the at least one icon display page is scaled down according to the touch instruction for the page slide prompt, and the at least one scaled-down icon display page is displayed on the screen. By extending functions of the page slide prompt, display effects of the page can be enriched.

Referring to FIG. 9, FIG. 9 is a block diagram of an electronic device according to an embodiment of the present disclosure. As illustrated in FIG. 9, the electronic device may include at least one processor 701, such as a CPU, at least one communication interface 703, at least one memory 704 and at least one communication bus 702. The communication bus 702 is configured to implement connection and communication among these components. In embodiments of the present disclosure, the communication interface 703 of the electronic device may be a wired send port or a wireless device, such as an antenna device, which is configured to perform signaling or data communications with other node devices. The memory 704 may be a high-speed RAM memory or a non-volatile memory, such as at least one disk memory. Alternatively, the memory 704 may also be at least one storage device located remotely from the processor 701. The memory 704 stores a set of program codes, and the processor 701 is configured to call the program codes stored in the memory, and to perform operations: receiving a touch instruction for a page slide prompt input on any one of at least one icon display page; and scaling down the at least one icon display page according to the touch instruction for the page slide prompt, and displaying at least one scaled-down icon display page on a screen.

In an embodiment, the processor 701 is further configured to perform operations: scaling down the at least one icon display page according to the touch instruction for the page slide prompt when the duration of the touch instruction input on the page slide prompt is greater than a preset threshold.

In an embodiment, the processor 701 is further configured to perform operations: combining the at least one scaled-down icon display page into a three-dimensional object and displaying the three-dimensional object, in which, at least one side of the three-dimensional object corresponds to the at least one icon display page respectively.

In an embodiment, the processor 701 is further configured to perform operations: receiving a slide instruction input by a user on the page slide prompt; and displaying the at least one icon display page corresponding to the at least one side of the three-dimensional object in a scrolling mode according to the slide instruction.

In an embodiment, the processor 701 is further configured to perform operations: scaling up the at least one icon display page to restore a display state of the at least one icon display page when detecting that the user stops touching the page slide prompt.

In an embodiment, the processor 701 is further configured to perform operations: scaling down the at least one icon display page according to a preset scale-down ratio.

In an embodiment, the processor 701 is further configured to perform operations: obtaining an area size of a terminal screen; and scaling down the at least one icon display page according to the area size of the terminal screen and the preset scale-down ratio.

It should be noted that, embodiments of the present disclosure further provide a storage medium. The storage medium is configured to store application programs. The application programs are configured to perform the application icon previewing method illustrated in FIG. 2 and the application icon previewing method illustrated in FIG. 7 when executed.

It should be noted that, embodiments of the present disclosure further provide an application program. The application program is configured to perform the application icon previewing method illustrated in FIG. 2 and the application icon previewing method illustrated in FIG. 7 when executed.

It should be noted that, in order to simplify description the present disclosure, embodiments of the present disclosure are expressed as a series of action combinations, but it would be appreciated by those skilled in the art that the present disclosure is not limited to the order of the actions, because some steps may be executed in other orders or be executed at the same time. In addition, it would be further appreciated by those skilled in the art that embodiments described in the specification are preferred embodiments, actions and modules involved therein may not be necessary for the present disclosure.

In the above embodiments, the description of each embodiment is emphasized differently. For the part that is not described in detail in an embodiment, reference may be made to the related description in other embodiments.

It would be understood by those skilled in the art that all or a part of the steps carried by the method in the above-described embodiments may be completed by relevant hardware instructed by a program. The program may be stored in a computer readable storage medium. The storage medium may include a flash disk, a read-only memory (ROM), a random access memory (RAM), a magnetic disk, an optical disk, or the like.

The content downloading method, the related device and the system provided by the embodiments of the present disclosure are described in detail. Specific examples are used herein to describe the principle and implementation of the present disclosure, and the above description of the embodiments is used to help to understand the method and core ideas of the present disclosure. Meanwhile, those skilled in the art may make modifications to the specific implementations and application scope according to the idea of the present disclosure. As descried above, the contents of the specification should not be construed to limit the present disclosure.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply relative importance or significance. Thus, the feature defined with “first” and “second” may comprise one or more this feature. In descriptions of the present disclosure, unless specified otherwise, “a plurality of” means at least two, such as two or three.

Any process or method described in a flow chart or described herein in other ways may be understood to include one or more modules, segments or portions of codes of executable instructions to implement specified logical function(s) steps in the process, and the scope of a preferred embodiment of the present disclosure includes other implementations, which may be performed in the order shown or discussed, including a substantially simultaneous order or in a reverse order according to the functions involved, which should be understood by those skilled in the art to which the embodiments of the present disclosure belongs.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The storage medium mentioned above may be read-only memories, magnetic disks or CD, etc. Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. An application icon previewing method, comprising:
receiving a touch instruction for a page slide prompt input on any one of at least one icon display page; and
scaling down the at least one icon display page according to the touch instruction, and displaying at least one scaled-down icon display page on a screen.

2. The method according to claim 1, before scaling down the at least one icon display page according to the touch instruction, further comprising:
determining whether a duration of the touch instruction input on the page slide prompt is greater than a preset threshold; and
scaling down the at least one icon display page according to the touch instruction when the duration of the touch instruction input on the page slide prompt is greater than the preset threshold.

3. The method according to claim 1, wherein, displaying at least one scaled-down display page on a screen comprises:
combining the at least one scaled-down icon display page into a three-dimensional object and displaying the three-dimensional object, wherein, at least one side of the three-dimensional object corresponds to the at least one icon display page respectively.

4. The method according to claim 3, after scaling down the at least one icon display page according to the touch instruction, and displaying at least one scaled-down icon display page on a screen, further comprising:
receiving a slide instruction input by a user on the page slide prompt; and
displaying the at least one icon display page corresponding to the at least one side of the three-dimensional object in a scrolling mode according to the slide instruction.

5. The method according to claim 1, after scaling down the at least one icon display page according to the touch instruction, and displaying at least one scaled-down icon display page on a screen, further comprising:
scaling up the at least one icon display page to restore a display state of the at least one icon display page when detecting that the user stops touching the page slide prompt.

6. The method according to claim 1, wherein, scaling down the at east one icon display page according to the touch instruction comprises:
scaling down the at least one icon display page according to a preset scale-down ratio.

7. The method according to claim 6, wherein, scaling down the at least one icon display page according to a preset scale-down ratio comprises:
obtaining an area size of a terminal screen; and
scaling down the at least one icon display page according to the area size of the terminal screen and the preset scale-down ratio.

8. An electronic device, comprising: a processor, a memory, a communication interface and a bus, wherein,
the processor, the memory and the communication interface are connected via the bus and communicate with each other;
the memory is configured to store executable program codes;
the processor is configured to execute a program corresponding to the executable program codes by reading the executable program codes stored in the memory, to perform following operations:
receiving a touch instruction for a page slide prompt input on any one of at least one icon display page; and
scaling down the at least one icon display page according to the touch instruction, and displaying at least one scaled-down icon display page on a screen.

9. The electronic device according to claim 8, wherein the processor is further configured to perform:
determining whether a duration of the touch instruction input on the page slide prompt is greater than a preset threshold; and
scaling down the at least one icon display page according to the touch instruction when the duration of the touch instruction input on the page slide prompt is greater than the preset threshold.

10. The electronic device according to claim 8, wherein the processor is further configured to perform:
combining the at least one scaled-down icon display page into a three-dimensional object and displaying the three-dimensional object, wherein, at least one side of the three-dimensional object corresponds to the at least one icon display page respectively.

11. The electronic device according to claim 10, wherein the processor is further configured to perform:
receiving a slide instruction input by a user on the page slide prompt; and
displaying the at least one icon display page corresponding to the at least one side of the three-dimensional object in a scrolling mode according to the slide instruction.

12. The electronic device according to claim 8, wherein the processor is further configured to perform:
scaling up the at least one icon display page to restore a display state of the at least one icon display page when detecting that the user stops touching the page slide prompt.

13. The electronic device according to claim 8, wherein the processor is further configured to perform:
scaling up the at least one icon display page to restore a display state of the at least one icon display page when detecting that the user stops touching the page slide prompt.

14. The electronic device according to claim 8, wherein the processor is further configured to perform:
obtaining an area size of a terminal screen; and
scaling down the at least one icon display page according to the area size of the terminal screen and the preset scale-down ratio.

15. A non-transitory computer readable storage medium, having application programs stored therein, wherein the application programs are configured to perform an application icon previewing method when executed, the application icon previewing method comprises:
receiving a touch instruction for a page slide prompt input on any one of at least one icon display page; and
scaling down the at least one icon display page according to the touch instruction, and displaying at least one scaled-down icon display page on a screen.

16. The non-transitory computer readable storage medium according to claim 15, wherein before scaling down the at least one icon display page according to the touch instruction, the method further comprising:
determining whether a duration of the touch instruction input on the page slide prompt is greater than a preset threshold; and
scaling down the at least one icon display page according to the touch instruction when the duration of the touch instruction input on the page slide prompt is greater than the preset threshold.

17. The non-transitory computer readable storage medium according to claim 15, wherein, displaying at least one scaled-down display page on a screen comprises:
combining the at least one scaled-down icon display page into a three-dimensional object and displaying the three-dimensional object, wherein, at least one side of the three-dimensional object corresponds to the at least one icon display page respectively.

18. The non-transitory computer readable storage medium according to claim 17, after scaling down the at least one icon display page according to the touch instruction, and displaying at least one scaled-down icon display page on a screen, the method further comprising:
receiving a slide instruction input by a user on the page slide prompt; and
displaying the at least one icon display page corresponding to the at least one side of the three-dimensional object in a scrolling mode according to the slide instruction.

19. The non-transitory computer readable storage medium according to claim 15, after scaling down the at least one icon display page according to the touch instruction, and displaying at least one scaled-down icon display page on a screen, the method further comprising:
scaling up the at least one icon display page to restore a display state of the at least one icon display page when detecting that the user stops touching the page slide prompt.

20. The non-transitory computer readable storage medium according to claim 15, wherein, scaling down the at least one icon display page according to the touch instruction comprises:
scaling down the at least one icon display page according to a preset scale-down ratio.
